SEQUENCE LISTING (5 sequences)

SEQ ID NO: 1 - DNA, 13 bp, Artificial
  MALDI-TOF spectrum obtained for liberated from the single polystyrene bead oligonucleotide of respective sequence
dcggatttatgca

SEQ ID NO: 2 - DNA, 13 bp, Artificial
  MALDI-TOF spectrum obtained for liberated from the single polystyrene bead oligonucleotide of respective sequence
datcgacctcaat

SEQ ID NO: 3 - DNA, 14 bp, Artificial
  MALDI-TOF spectrum obtained for liberated from the single polystyrene bead oligonucleotide of respective sequence
dattcgtttggaga

SEQ ID NO: 4 - DNA, 14 bp, Artificial
  MALDI-TOF spectrum obtained for liberated from the single polystyrene bead oligonucleotide of respective sequence
dattcgtctgcaga

SEQ ID NO: 5 - DNA, 14 bp, Artificial
  MALDI-TOF spectrum obtained for liberated from the single polystyrene bead oligonucleotide analogue of respective sequence, where y is 4-N-(4,9,13-triazatridecan-1-yl)-2′-deoxycytidine residue
dattygtgtgcaga

(19) United States
(12) Patent Application Publication
(10) Pub. No.: US 2013/0053258 A1
(43) Pub. Date: Feb. 28, 2013

(54) COMBINATORIAL LIBRARY, A METHOD FOR PREPARATION OF THAT COMBINATORIAL LIBRARY, A METHOD FOR SEQUENCE IDENTIFICATION, A METHOD FOR SEQUENCING THE ELEMENTS OF COMBINATORIAL LIBRARIES OF OLIGONUCLEOTIDES AND/OR OLIGONUCLEOTIDE ANALOGUES, THE USE OF A LINKER TO GENERATE COMBINATORIAL LIBRARIES AND A SEQUENCE IDENTIFICATION SET

(71) Applicants: Wojciech T. Markiewicz, Poznan (PL); Anna Rulka, Poznan (PL)

(72) Inventors: Wojciech T. Markiewicz, Poznan (PL); Anna Rulka, Poznan (PL)

(73) Assignee: INSTYTUT CHEMII BIOORGANICZNEJ PAN, POZNAN (PL)

(21) Appl. No.: 13/636,524

(22) PCT Filed: Mar. 21, 2011
(86) PCT No.: PCT/PL2011/000033

§ 371 Date: Sep. 24, 2012

(30) Foreign Application Priority Data
Mar. 22, 2010 (PL) P-390 797

(51) Int. Cl. C40B 40/06; C40B 20/08; C40B 50/14

(52) U.S. Cl. 506/6; 506/16; 506/30

(57) ABSTRACT

The invention provides a combinatorial library, a method for preparation of that combinatorial library, a method for sequence identification, a method for sequencing the elements of combinatorial libraries of oligonucleotides and/or oligonucleotide analogues, the use of a linker to generate combinatorial libraries and a sequence identification set. More precisely, the objective of the invention is the ability to “read” sequences of selected elements of combinatorial libraries of freely modified synthetic oligonucleotides. The solution may be used both for researching for leading compounds in the pharmaceutical industry, and as a tool for studying the properties of oligonucleotides in the aspect of their potential use in experimental antisense or antigen therapy. The invention develops an appropriate strategy for determining the structure of isolated library elements, as usefulness of the combinatorial library depends on the ability to recognize the structure of its elements. Thanks to the developed and presented method for sequencing combinatorial oligonucleotide libraries it is possible to indisputably identify the sequences of biologically active elements selected by the combinatorial synthesis method.

The invention provides a combinatorial library, a method for preparation of that combinatorial library, a method for sequence identification, a method for sequencing the elements of combinatorial libraries of oligonucleotides and/or oligonucleotide analogues, the use of a linker to generate combinatorial libraries and a sequence identification set. More precisely, the objective of the invention is the ability to “read” sequences of selected elements of combinatorial libraries of freely modified synthetic oligonucleotides. The solution may be used both for researching for leading compounds in the pharmaceutical industry, and as a tool for studying the properties of oligonucleotides in the aspect of their potential use in experimental antisense or antigen therapy. The invention develops an appropriate strategy for determining the structure of isolated library elements, as usefulness of the combinatorial library depends on the ability to recognize the structure of its elements. Thanks to the developed and presented method for sequencing combinatorial oligonucleotide libraries it is possible to indisputably identify the sequences of biologically active elements selected by the combinatorial approach.

Combinatorial synthesis consists in deliberate construction of a set of molecules based on logical design of chemical reactions that lead to linking selected monomers in various combinations. Thus obtained library is then searched in order to identify elements having desired properties. As a result of the selection process, active molecules of unknown structure are isolated from the library.

Following approaches were proposed to solve the problem of “reading” the structure of combinatorial library elements:

A special case are oligonucleotide libraries with elements that do not include modification; in such case, direct amplification of the element, followed by sequencing of the obtained copy, may be applied [C. Tuerk, L. Gold, Science, 1990, 24:505; A. D. Ellington, J. W. Szostak, Nature, 1990, 346:818].

Another method is to infer the library element structure in recursive deconvolution algorithm [E. Erb; K. D. Janda; S. Brenner, Proc. Natl. Acad. Sci. USA, 1994, Vol. 91:11422; K. D. Janda; Proc. Natl. Acad. Sci. USA; 1994, Vol. 91:10779]. The basic assumption is to define sublibraries, or partial libraries, at every stage of oligomer synthesis.

An alternative to recurrent deconvolution is the method consisting in reading the structure of tags coding the sequence of the original library element.[S. Brenner, R. A. Lerner, Proc. Natl. Acad Sci. USA, 1992, Vol. 89:5381; M. C. Needels, D. G. Jones, E. H. Tate, G. L. Heinkel, L. M. Kochersperger, W. J. Dower, R. W. Barret, M. A Gallop, Proc. Natl. Acad. Sci. USA, 1993, Vol. 90:10700]. Reports included oligonucleotide-coded oligonucleotide libraries [P. A. Sacca, A. Fontana, J. M. Montserrat, A. M. Iribarren, Chemistry&Biodiversity, 2004, 1:595], as well as the use of different types of tags not bound in sequences, such as those based on trityl skeleton [M. S. Shchepinov, R. Chalk, E. M. Southern, Tetrahedron, 2000, 56:2713], pyrrole [R. H. C. Scott, C. Barnes, U. Gerhard, A. Balasubramanian, Chem. Commun., 1999, 1331], halogen benzene derivatives [M. H. J. Ohlmeyer, R. N. Swanson, L. W. Dillard, J. C. Reader, G. Asouline, R. Kobayashi, M. Wigler, W. C. Still, Proc. Natl. Acad. Sci. 1993, 90:10922; H. P. Nestler, P. A. Bartlett, W. C. Still, J. Org. Chem., 1994, 59:4723], and dialkylamine tags [Z.-J. Ni, D. Maclean, C. P. Holmes, M. M. Murphy, B. Ruhland, J. W. Jacobs, E. M. Gordon, M. A. Gallop, J. Med. Chem. 1996, 39:1601; W. L. Fitch, T. A. Baer, W. Chen, F. Holden, C. P. Holmes, D. Maclean, N. Shah, E. Sullivan, M. Tang, P. Waybourn, J. Comb. Chem. 1999, 1:188], as well as fluorous derivatives of carboxylic acids [J. E. Hochlowski, D. N. Whittern, T. J. Sowin, J. Comb. Chem., 1999, 1:291], fluorophores [R. H. Scott, S. Balasubramanian, Bioorg, Med. Chem. Lett., 1997, Vol. 7, No. 12:1567; B. J. Egner, S. Rana, H. Smith, N. Bouloc, J. G. Frey, W. S. Bocklesby, M. Bradley, Chem. Commun., 1997, 735] and compounds with characteristic IR absorption bands [S. S. Rahman, D. J. Busby, D. C. Lee, J. Org. Chem., 1998, 63:6196]. In addition, a method for coding the structure of combinatorial library elements by microchip-coded information was developed [E. J. Moran, S. Sarshar, J. F. Cargill, M. M. Shahbaz, A. Lio, A. M. M. Mjalli, R. W. Armstrong, J. Am. Chem. Soc., 1995, 117:10787]. Methods providing direct information on compound structure include positional coding within oligonucleotide arrays [S. P. A. Fodor; D. Solas, Science, 1991, 767; K. S. Lam, M. Renil, Curr. Opin. Chem. Biol. 2002, 6:353; R. Frank, Tetrahedron, 1992, 48:9217].

An alternative to tagging methods is the controlled preparation of shorter sequences in the oligonucleotide synthesis process followed by their analysis by means of mass spectrometry [R. S. Youngquist, G. R. Fuentes, M. P. Lacey, T. Keough, J. Am. Chem. Soc., 1995, 117:3900; C. Hoffman, D. Blechschmidt, R. Kruger, M. Karas, C. Griesinger, J. Comb. Chem., 2002, 4:79].

The method consists in that at each stage of library generation, elongation of ca. 10% of peptide chains is terminated. This leads to formation of oligomers of different chain lengths. When analyzed by MALDI mass spectrometry, products of such synthesis give spectra containing series of signals. Mass differences between adjacent peaks provide information on the peptide structure.

Patent application no. US20040265912 A1 (publication date Dec. 30, 2004) describes composition and methods for making and using a combinatorial library to identify modified thioaptamers that bind to, and affect the immune response of a host animal, transcription factors such as IL-6, NF-κB, AP-1 and the like. Composition and methods are also provided for the treatment of viral infections, as well as, vaccines and vaccine adjuvants are provided that modify host immune responses

Patent application no. WO2005003291 (publication date Jan. 13, 2005) describes composition and methods for making and using a combinatorial library having two or more beads, wherein attached to each bead is a unique nucleic acid aptamer that have disposed thereon a unique sequence. The library aptamers may be attached covalently to the one or more beads, which may be polystyrene beads. The aptamers may include phosphorothioate, phosphorodithioate and/or methylphosphonate linkages and may be single or double stranded DNA, RNA, or even PNAs.

Patent application no. WO2005037053 (publication date Apr. 28, 2005) composition and methods for making and using a combinatorial library to identify thioaptamers that bind to targets on or about pathogens. Compositions, sets and methods are also provided for the identification of pathogens, e.g., viral, bacterial or other proteins related infectious disease, as well as, vaccines and vaccine adjuvants are provided that modify host immune responses.

Patent application no. U.S. Pat. No. 6,287,765 (publication date Sep. 11, 2001) describes multimolecular devices and drug delivery systems prepared from synthetic heteropolymers, heteropolymeric discrete structures, multivalent heteropolymeric hybrid structures, aptameric multimolecular devices, multivalent imprints, tethered specific recognition devices, paired specific recognition devices, nonaptameric multimolecular devices and immobilized multimolecular structures are provided, including molecular adsorbents and multimolecular adherents, adhesives, transducers, switches, sensors and delivery systems. Methods for selecting single synthetic nucleotides, shape-specific probes and specifically attractive surfaces for use in these multimolecular devices are also provided. In addition, paired nucleotide-nonnucleotide mapping libraries for transposition of selected populations of selected nonoligonucleotide molecules into selected populations of replicable nucleotide sequences are described.

Patent applications no. US 20060073485 (publication date Apr. 6, 2006) and U.S. Pat. No. 7,316,931 (publication date Jan. 8, 2008) mass tagging methods are provided that, when incorporated to the analyzed substance, increase the mass spectrometer detection sensitivity and molecular discrimination. In particular the methods are useful for discriminating tagged molecules and fragments of molecules from chemical noise in the mass spectrum.

Despite the diversity of proposals and current state of art techniques presented above, they lack a simple, universal, direct and inexpensive technique allowing for determination of the structure of selected elements of oligonucleotide libraries while being universal enough to allow structure determinations of freely modified oligonucleotides.

The aim of the invention is providing the ability to “read” sequences of selected elements of combinatorial libraries of freely modified synthetic oligonucleotides. Combinatorial synthesis is used mostly for researching for leading compounds in the pharmaceutical industry. However, it is also used as a tool for studying the properties of oligonucleotides in the aspect of their potential use in experimental antisense or antigen therapy. The main problem associated with combinatorial synthesis is the development of an appropriate strategy for determining the structure of isolated library elements, as usefulness of the combinatorial library depends on the ability to recognize the structure of its elements. Thanks to the developed and presented method for sequencing combinatorial oligonucleotide and/or oligonucleotide analogue libraries it is possible to indisputably identify the sequences of biologically active elements selected by the combinatorial approach.

This goal, combined with the potential of using a universal, direct and inexpensive/accessible technique allowing for identification of structure of a freely modified oligonucleotide, is achieved in this invention. Thus, the solution according to the invention will contribute to the development of novel therapies of cancer and viral diseases.

The invention provides a combinatorial library of oligonucleotides and/or oligonucleotide analogues characterized in that it includes a linker of formula (I)

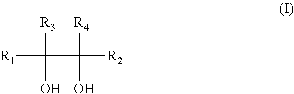

chemically linked to the support, where R₁ and R₂ are independently two substituents of any type terminated with functional groups, and R₃ and R₄ are independent or together form a cyclic system, and
at least one oligonucleotide and/or oligonucleotide analogue comprising a part of combinatorial library oligonucleotide and/or oligonucleotide analogue pool, wherein the oligonucleotides and/or oligonucleotide analogues are comprised of natural nucleotides and/or nucleotide analogues.

Preferably, when in the linker of formula (I)

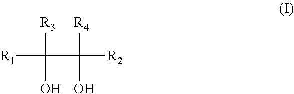

R₃ and R₄ together form a cyclic system, the linker preferably comprises a residue of formula (II)

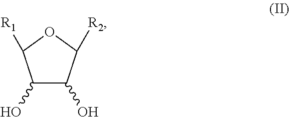

where R₁ and R₂ are independent substituents terminated with any functional groups.

The invention also provides a method of preparation of a combinatorial library of oligonucleotides and/or oligonucleotide analogues, characterized in that it includes
a) preparation of a linker of formula (I)

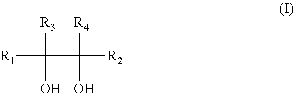

chemically linked to the support, where R₁ and R₂ are independently two substituents of any type terminated with functional groups, and R₃ and R₄ are independent or together form a cyclic system,
b) chemical linking of the linker and the support;
c) preparation of a series of nucleotides and/or nucleotide analogues having at least two substituents of functional nature, wherein each nucleotide and/or nucleotide analogue has at least one corresponding terminating agent, wherein the functional group of the nucleotide and/or nucleotide analogue, to which another unit of the growing chain is added during the synthesis, is blocked in the structure of the terminating agent by a protective group stable in the oligonucleotide and/or oligonucleotide analogue synthesis conditions and labile in final product deprotection conditions, without breaking the linker between the library element and the support,
wherein the terminating agents are used in oligonucleotide synthesis together with the nucleotides and/or nucleotide analogues, wherein their quantitative ratio is fixed or variable, not higher than 50% of the terminating agent in relation to the monomer at successive stages of oligonucleotide and/or oligonucleotide analogue synthesis.

Preferably, when the terminating agents are used preferably from the stage of linking the fifth monomer, particularly preferably the eight monomer, the monomer is used at the terminator/monomer ratio of at least 7%.

The invention also provides a method of sequence identification preceded or not preceded by a combinatorial oligonucleotide or oligonucleotide analogue library element selection stage, characterized in that it comprises the stage described above and that a single support bead is isolated, followed by cleavage of the vicinal diol system in the linker as a result of an oxidizing agent consisting in ammonium periodate NH₄IO₄ or ammonium periodate of formula [R₁R₂R₃R₄N]⁺[IO₄]⁻, wherein R₁, R₂, R₃ and R₄ are independently alkyl groups or hydrogen atoms, thus releasing the oligonucleotide comprised of nucleotides and/or oligonucleotide analogues from the support, wherein in case when the linker structure is as in formula (II), final detachment of the oligonucleotide comprised of nucleotides and/or oligonucleotide analogues from the support is a result of treatment with a basic agent; next, the mixture of oligonucleotides of different length, detached from the support bead is submitted to spectroscopic analysis.

Preferably, the basic agent is methionine.

Another aspect of the invention is the method of sequencing the elements of combinatorial oligonucleotide and/or oligonucleotide analogue libraries characterized in that it involves the stages described above and that the type and order of nucleotides and/or their analogues in the sequence is determined from calculation of mass differences between two adjacent signals within the spectrum, corresponding to nucleotide or analogue masses, wherein calculation starts with the signal of the highest m/z value.

Another aspect of the invention is the use of the linker of formula (I),

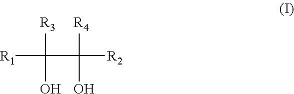

chemically linked to the support, where R₁ and R₂ are independently two substituents of any type terminated with functional groups, and R₃ and R₄ are independent or together form a cyclic system, and
at least one oligonucleotide and/or oligonucleotide analogue comprising a part of combinatorial library oligonucleotide and/or oligonucleotide analogue pool, wherein the oligonucleotides and/or oligonucleotide analogues are comprised of natural nucleotides and/or nucleotide analogues for preparation of combinatorial oligonucleotide and/or oligonucleotide analogue libraries.

Preferably, when in the linker of formula (I)

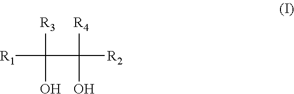

R₃ and R₄ together form a cyclic system, the linker preferably comprises a residue of formula (II)

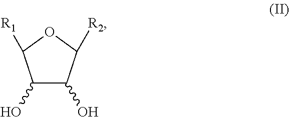

where R₁ and R₂ are independent substituents terminated with any functional groups.

Another aspect of the invention is a sequence identification set characterized in that it includes a linker of formula (I),

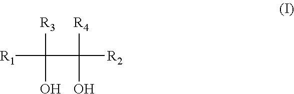

chemically linked to the support, where R₁ and R₂ are independently two substituents of any type terminated with functional groups, and R₃ and R₄ are independent or form a cyclic system, and
at least one oligonucleotide and/or oligonucleotide analogue comprising a part of combinatorial library oligonucleotide and/or oligonucleotide analogue pool, wherein the oligonucleotides and/or oligonucleotide analogues are comprised of natural nucleotides and/or nucleotide analogues

Preferably, the linker of formula (I)

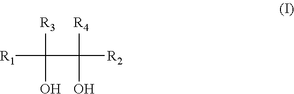

R₃ and R₄ together form a cyclic system, the linker preferably comprises a residue of formula (II)

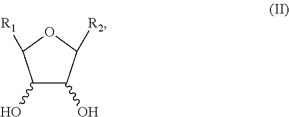

where R₁ and R₂ are independent substituents terminated with any functional groups.

At the same time, one must keep in mind that whenever the aforementioned terms are used in the description, they should be understood as follows:
Combinatorial library element as defined herein is the compound formed in combinatorial synthesis and thus being a part of the obtained library.
Support as defined herein is a solid or macromolecular carrier containing on its surface or in its structure functional groups capable of binding an appropriate linker, and allowing for the conduct of chemical synthesis, i.e. stable in the synthetic conditions.
Analogue is used herein in two meanings:
a) nucleotide analogue—a chemical compound which can be sequentially linked by means of chemical synthesis, forming compounds of linear and/or branched chain structure and containing or not containing in its structure natural nucleic bases and derivatives or analogues thereof;
b) oligonucleotide analogue—an oligonucleotide chain containing in its composition one or more nucleotide analogues or entirely comprised of such analogues.

The enclosed figures facilitate better explanation of the nature of the invention.

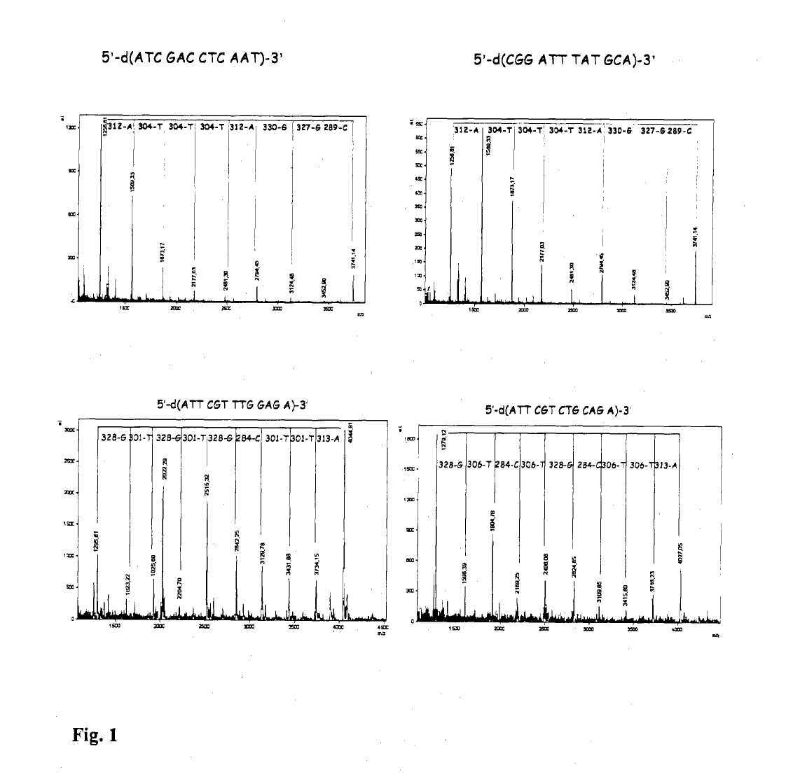

FIG. 1 presents exemplary MALDI-TOF spectra obtained for oligonucleotides of following respective sequences: 5′-d(CGG ATT TAT GCA)-3′, 5′-d(ATC GAC CTC AAT)-3′, 5′-d(3ATT CGT TTG GAG A)-3′, 5′-d(ATT CGT CTG CAG A)-3′.

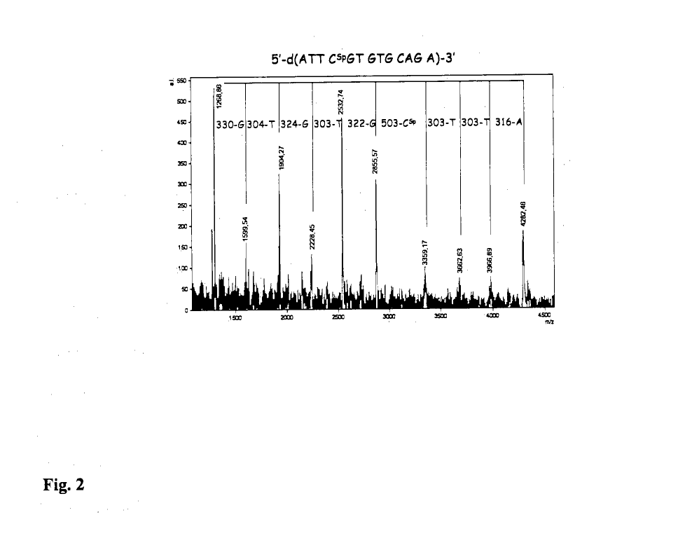

FIG. 2 presents exemplary MALDI-TOF spectrum obtained for liberated from the single polystyrene bead oligonucleotide analogue of respective sequence, where C^{Sp}=4-N-(4,9,13 -Triazatridecan-1-yl)-2′-deoxycytidine, the modified 2′-deoxycytidine residue.

For better understanding of the invention, the following example solutions are presented.

### EXAMPLES

### Example 1

Preparation of “oxylabile” support for combinatorial oligonucleotide libraries. Below is and outline of preparation of “oxylabile” support, described in detail further in the description of this invention.

Preparation of “oxylabile” support: i) TMSCl, Py; ii) p-toluenesulfonyl chloride, Py; iii) NH₃ aq; iv) DMTCl, Py; v) 2,2′-(ethylenedioxy)-bis(ethylamine), Py; vi) DCC, DMAP, Et₃N, CH₂Cl₂, vii) Ac₂O, NMI, 2,6-lutidine, MeCN.

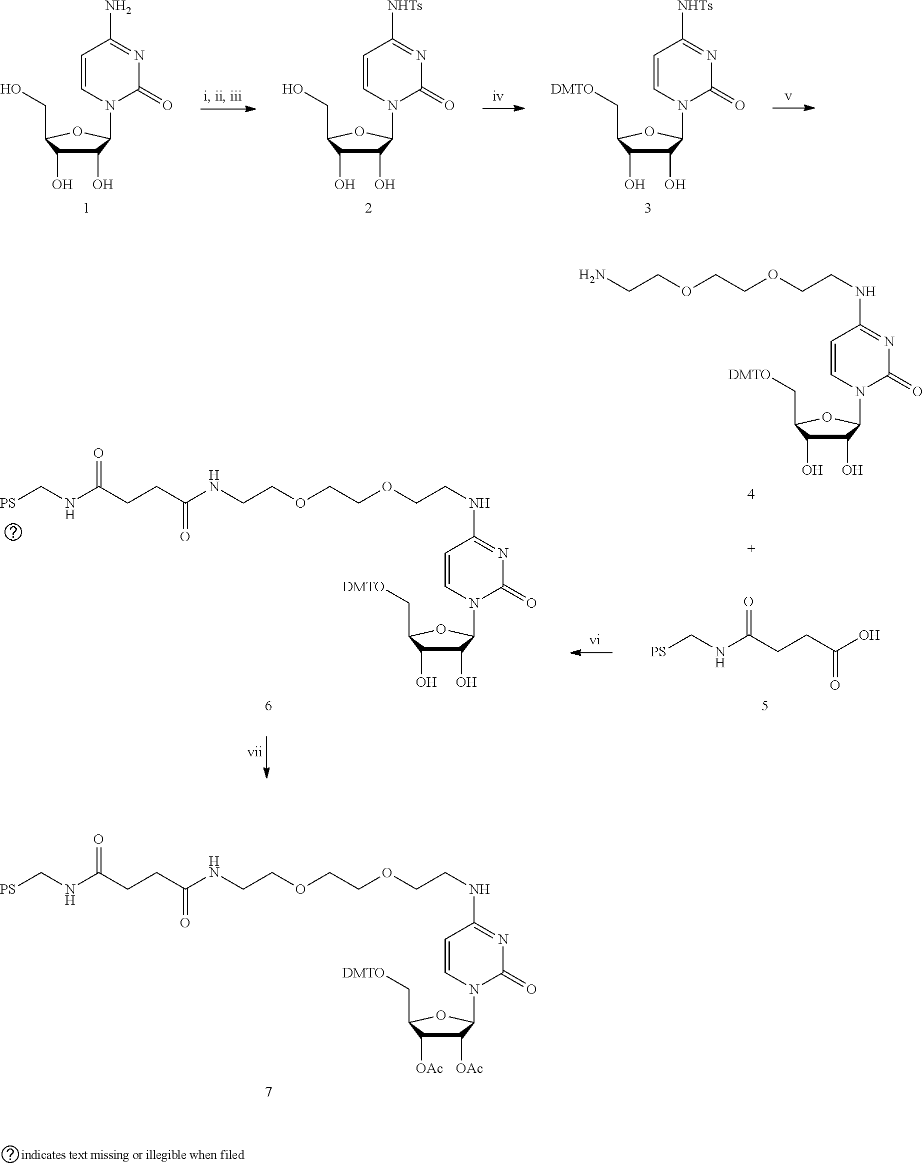

In order to obtain the “oxylabile” support (7), the following stages have to be performed:

### 1.1. 4-N-p-Toluenesulfonyl-5′-O-(4,4′-dimethoxytrityl)cytidine (3)

Cytidine hydrochloride (2.5 g, 8.96 mmol, 1 eq.) was evaporated with pyridine (three times) and then dissolved in 20 mL pyridine; next, trimethylsilyl chloride (6.5 mL, 44.8 mmol, 5 eq.) was added. After about 1 hour stirring at room temperature, the substrate was quantitatively converted as shown by TLC (CH₂Cl₂/MeOH, 9:1). The silylation product was directly submitted to next reaction. p-Toluenesulfonyl chloride (4 g, 17.9 mmol, 2 eq.) was added to the reaction mixture. The resulting solution was refluxed for 1.5-2 hours. After this time, TLC analysis showed full substrate conversion. Excess silyl and tosyl chlorides were decomposed by adding saturated NaHCO₃ solution. The aqueous phase was extracted with three portions of methylene chloride. Combined organic layers were dried over anhydrous Na₂SO₄. The solvents were evaporated under reduced pressure. Next, the crude product was dissolved in 10 mL of MeOH and 15 mL of aqueous NH₃ solution were added. The reaction mixture was left on a magnetic stirrer for about 45 minutes at room temperature. After this time, TLC analysis showed complete deprotection of 4-N-(p-toluenesulfonyl)cytidine hydroxyl groups. The solvents were evaporated under reduced pressure. The crude product was dried by evaporation with pyridine (three times). Dry 4-N-(p-toluenesulfonyl)cytidine was dissolved in 20 mL of pyridine and 4,4′-dimethoxytrityl chloride (3.34 g, 9.85 mmol, 1.1 eq.) was added. The reaction mixture was left on a magnetic stirrer for about 1 hour at room temperature. The reaction was stopped by adding saturated solution of NaHCO₃, which was then extracted with three portions of CH₂Cl₂. After organic layers were combined, dried on anhydrous Na₂SO₄ and evaporated under reduced pressure, the dry product was purified by chromatography (CH₂Cl₂/MeOH, 2%). Pure 4-N-p-toluenesulfonyl-5′-O-(4,4′-dimethoxytrityl)cytidine (3) was obtained as white foam. 5.44 g (85%) of white solid was obtained after lyophilization from benzene.

¹H NMR (DMSO): δ (ppm) 12.17 (s, 1H, HN4); 7.63 (d, J=8.4 Hz, 1H, H6); 7.36-7.39 (m, 4H, H—Ar); 7.30-7.34 (m, 5H, H—Ar); 7.24-7.28 (m, 4H, H—Ar); 6.89-6.92 (m, 4H, H—Ar); 6.23 (d, J=8 Hz, 1H, H5); 5.68 (d, J=2.4 Hz, 1H, OH); 5.59 (d, J=4.8 Hz, 1H, OH); 5.16 (d, J=6.8 Hz, 1H, H1′); 4.14-4.17 (m, 1H, H4′); 4.06-4.09 (m, 1H, H2′); 3.96-3.98 (m, 1H, H3′); 3.76 (s, 6H, OCH₃); 3.23-3.32 (m, 2H, H5′, H5″); 2,37 (s, 3H, CH₃). ¹³C NMR (DMSO): δ (ppm) 159.51 (C4); 158.16 (C—OCH₃, DMTr); 149.51 (C2); 144.35 (Ar); 142.34 (C—CH₃, Tos); 142.08 (C6); 139.69; 136.10; 135.45; 135.08; 129.74; 129.63, 129.35; 128.30; 127.92; 127.73; 126.85; 126.04; 123.88; 113.25 (Ar); 95.67 (C5); 89.83 (C1′); 85.96 (4° C., DMTr); 82.06 (C4′); 73.08 (C2′); 68.78 (C3′); 62.04 (C5′); 55.01 (OCH₃); 20.93 (CH₃).

### 1.2. 4-N-(8-Amino-3,6-dioxaoctyl)-5′-O-(4,4′-dimethoxytrityl)cytidine (4)

4-N-p-Toluenesulfonyl-5′-O-(4,4′-dimethoxytrityl)cytidine (3) (4.44 g, 6.35 mmol, 1 eq.) was evaporated three times with pyridine to remove the trace amounts of water. Next, the substrate was dissolved in pyridine (20 mL) and 2,2′-(ethylenedioxy)-bis(ethylamine) (5.5 mL, 44.45 mmol, 7 eq.) was added. The flask was tightly closed and placed overnight in a drying oven at 80° C. In the morning, TLC analysis (MeOH:H₂O:CH₃NH₂, 7:2:1), was performed, showing quantitative conversion of the substrate. The reaction mixture was diluted with 30 mL of H₂O. The aqueous layer was extracted with three portions of AcOEt (in case of emulsification, the solution was centrifuged). Organic layers were combined and dried/over anhydrous Na₂SO₄. After the solvents were evaporated under reduced pressure, the crude product was purified by column chromatography (CH₂Cl₂/MeOH, 6:4). 3.5 g (82%) of pure 4-N-(8-Amino-3,6-dioxaoctyl)-5′-O-(4,4′-dimethoxytrityl)cytidine (4) was obtained as white foam.

¹H NMR (DMSO): δ (ppm) 7.86 (t, J=5.6 Hz, 1H, H—N4); 7.72 (d, J=7,6 Hz, 1H, H5); 7.22-7.39 (m, 9H, H—Ar); 6.91 (m, 4H, H—Ar); 5.78 (d, J=2.8 Hz, 1H, H1′); 5.60 (d, J=7.6 Hz, 1H, H6); 4.08 (t, J=6 Hz, H4′); 3.93-3.95 (m, 2H, H2′, H3”); 3.75 (s, 6H, OCH₃); 3.50-3,55 (m, 8H, H5′, H5″, CH₂ of hydroxydiethoxyethyl); 3.20-3.43 (m, 6H, CH₂ of hydroxydiethoxyethyl); 2.66 (t, J=5.6 Hz, 2H, NH₂).

¹³C NMR (DMSO): δ (ppm) 163.43 (C4); 158.12 (C—OCH₃, DMTr); 155.06 (C2); 144.71 (C6); 139.81; 135.46; 135.29; 129.87; 127.72; 126.77; 113.23 (Ar); 94.44 (C5); 89.78 (C1′); 85.77 (4° C., DMTr); 81.65 (C4′); 74.08 (C2′); 71.77 (CH₂ of hydroxydiethoxyethyl); 69.58; 69.55 (CH₂ of hydroxydiethoxyethyl); 69.27 (C3′); 68.65 (CH₂ of hydroxydiethoxyethyl); 62.73 (C5′); 55.03 (OCH₃); 40.77 (CH₂ [hydroxydiethoxyethyl]).

### 1.3. “Oxylabile Support” (7)

Methylamine-functionalized polystyrene support (50mg) was suspended in, l mL of anhydrous CH₂Cl₂ and succinic anhydride (50 mg), Et₃N (50 μL) and DMAP (20 mg) were added. The flask was tightly closed and shook overnight at room temperature. In the morning, the support was filtered off and washed with MeOH (50 mL) and CH₂Cl₂ (50 mL). Next, the support was dried in the air. The resulting carboxyl group-carrying support (5) (1 g) was suspended in 10 mL of methylene chloride. 4-N-(8-Amino-3,6-dioxaoctyl)-5′-O-(4,4′-dimethoxytrityl)cytidine (5) (1 g, 1.5 mmol, 1 eq.), DCC (700 mg, 1.5 mmol, 1 eq.), Et₃N (450 μL, 1.5 mmol, 1 eq.) and DMAP (20 mg) were added to the suspension. The mixture was shook overnight at room temperature. The support was filtered off and washed with methanol (50 mL) and methylene chloride (50 mL). 10 mL of NH₃ aq. (32%) were added to decompose the by-products. The reaction was conducted for 4 hours at 60° C. Next, support beads (6) were suspended in MeCN (10 mL) and acetic anhydride (500 μL), N-methylimidazole (1 mL) and 2,6-lutidine(500 μL) were added. The mixture was shook for 2 hours; after this time, support 7 was filtered off, washed with MeOH, CH₂Cl₂ and dried in the air.

The synthesis termination procedure was developed for the purposes of peptide library sequencing. Therefore, the original form of this procedure may be used only in case of short oligonucleotides.

The idea of using a single terminating agent regardless of the type of unit attached at particular stage turned out to be useful in case of short peptide chains. Large diversity of monomers used was an argument for such solution. However, applying this approach resulted with chaos that makes difficult to interpret and unambiguously identify signals in MALDI spectra of oligonucleotides from combinatorial libraries.

A series of synthesis termination agents was designed so as to comply with the above assumptions. Nucleoside 3′-phosphoramidites with 5′-hydroxyl function protected with fluorenylmethyloxycarbonyl group (Fmoc), stable in the conditions of oligonucleotide synthesis, were used. This is a base-labile group, which is easily cleaved by β-elimination in ammonia solutions used for oligonucleotide deprotection, thus freeing the 5′-hydroxyl group of the nucleoside.

The synthesis of nucleoside phosphoramidites with base-labile Fmoc group in 5′-hydroxyl position was performed in three stages.

Preparation of oligonucleotide synthesis terminators: i) benzoyl chloride, Py; ii) iso-butyryl chloride, Py; iii) fluorenylmethyloxycarbonyl chloride, Py; iv) bis(diisopropylamine)-(2-cyanoethyl)-phosphine, thioethyltetrazole, CH₂Cl₂.

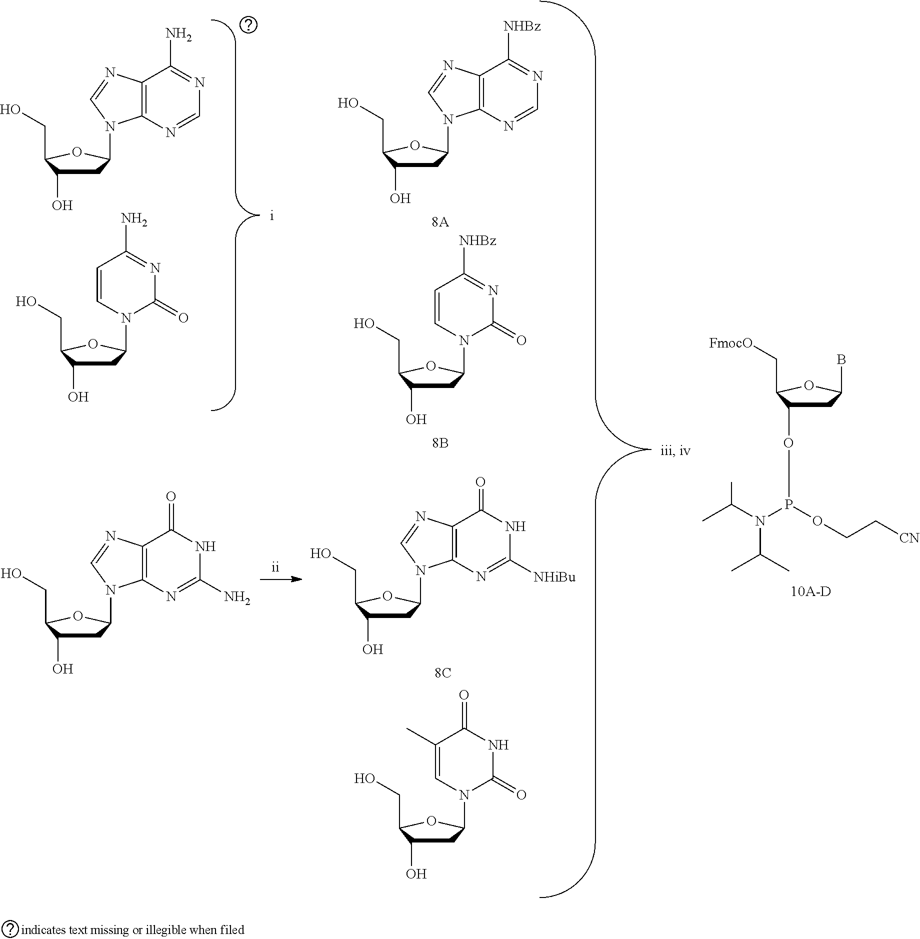

The synthesis of terminating agents (N-protected 5′-O-fluorenylmethyloxycarbonyl-2′-deoxynucleoside 3′-phosphoramidites) was conducted in the following stages:

### 2.1. N-Protected 2′-deoxynucleosides (8 A-C)

N-protected 2′-deoxynucleosides were obtained from 2′-deoxynucleosides (8 mmol), which had been evaporated three times with pyridine and dissolved in pyridine. Next, trimethylsilyl chloride (4.5 mL, 40 mmol, 5 eq.) was added. The reaction mixture was left on a magnetic stirrer for about 1.5 hours at room temperature. After complete conversion of the substrate was confirmed (TLC—CH₂Cl₂/MeOH, 9:1), benzoyl chloride (1.8 mL, 16 mmol, 2 eq.) was added and the stirring was continued for 2 hours. After this time, no substrate was observed. The reaction mixture was cooled down in ice bath and 25 mL of ammonia solution were added portionwise. After 30 minutes, the solvents were evaporated under reduced pressure. The residue was dissolved in 35 mL of H₂O and 25 mL of AcOEt were added. The mixture was shook and placed in a refrigerator. After the mixture was cooled down, white soft flaky solid precipitated. The solid was filtered off, washed with AcOEt and dried under reduced pressure over P₂O₅.

### B) 6-N-Benzoyl-2′-deoxyadenosine (2.5 g, 89%)

¹H NMR (DMSO): δ (ppm) 11.18 (s, 1H, HNCO); 8.74 (s, 1H, H8); 8,73 (s, 1H, H2); 8.14 (m, 2H, H—Ar); 7.28-7.67 (m, 3H, H—Ar); 6.49 (t, J=4.8 Hz, 1H, H1′); 5.43 (d, 1H, 3′OH); 5.06 (t, 1H, 5′OH); 4.46 (m, 1H, H4′); 3.91 (m, 1H, H3′); 3.52-3.65 (m, 2H, H5′, H5″); 2.75-2.82 (m, 1H, H2′); 2.34-2.39 (m, 1H, H2″).

¹³C NMR (DMSO): δ (ppm) 165.70 (CONH); 151.89 (C6); 151.48 (C2); 150.29 (C4); 143.06 (C8); 133.37; 132.42; 128.55; 128.45 (Ar); 124.08 (C5); 87.99 (C4′); 83.72 (C1′); 70.68 (C3′); 61.58 (C4′); 38.97 (C2′).

### B) 4-N-Benzoyl-2′-deoxycytidine (2.47 g, 91%)

¹H NMR (DMSO): δ (ppm) 11.23 (s, 1H, H—N4); 8.41 (d, J=7.2 Hz, 1H, H6); 8.01 (m, 2H, H—Ar); 7.48-7.65 (m, 3H, H—Ar); 6.16 (t, J=6 Hz, 1H, H1′), 5.30 (d, J=4.2 Hz, 1H, 3′OH); 5.11 (t, J=5.1 Hz, 1H, 5′OH); 4.26 (m, 1H, H4′); 3.89 (m, 1H, H3′); 3.55-3.68 (m, 2H, H5′, H5″); 2.28-2.36 (m, 1H, H2′); 2.02-2.1 (m, 1H, H2″),

¹³C NMR (DMSO): δ (ppm) 167.41 (COOPh); 162.98 (C4); 154.36 (C2); 144.96 (C6); 133.18; 132.69; 130.02; 128.43 (Ar); 96.03 (C5); 87.94 (C4′); 86.19 (C1′); 69.91 (C3′); 60.92 (C5′); 40.89 (C2′).

### C) 2-N-iso-Butyryl-2′-deoxyguanosine (2.15 g, 87%)

¹H NMR (DMSO): δ (ppm) 12.06 (s, 1H, HNCO); 11.71 (s, 1H, H—N1); 8.23 (s, 1H, H8); 6.22 (t, J=6.6 Hz, 1H, H1′); 5.37 (d, 1H, 3′OH); 4.95 (t, 1H, 5′OH); 4.37 (m, 1H, H4′); 3.84 (m, 1H, H3′); 3.47-3.59 (m, 2H, H5′, H5″); 2.73-2.82 (m, 1H, CH, i-Bu group); 2.49-2.59 (m, 1H, H2′); 2.24-2.31 (m, 1H, H2″); 1.12 and 1.09 (s, 6H, CH₃ of i-Bu).

¹³C NMR (DMSO): δ (ppm) 179.99 (CONH); 154.86 (C6); 148.36 (C4); 148.05 (C2); 137.46 (C8); 120.15 (C5); 87,72 (C4′); 82.98 (C1′); 70.48 (C3′); 61.44 (C5′), 39.69 (C2′); 34.71 (CH of i-Bu); 18.84 (CH₃ of i-Bu).

### 2.2. N-Protected 5′-O-fluorenylmethyloxycarbonyl-2′-deoxynucleosides (9 A-D)

N-protected nucleosides or thymidine(1 eq.) were evaporated three times with pyridine. Then, the compounds were dissolved in pyridine, and fluorenylmethyloxycarbonyl chloride (1.1 eq.) was added. The reaction mixture was left on a magnetic stirrer for 1.5-2 hours. After this time, TLC analysis showed full substrate conversion. Saturated NaHCO₃ solution was added. The aqueous layer was extracted with CH₂Cl₂. Extracts were combined, dried on anhydrous Na₂SO₄ and evaporated under reduced pressure. Crude products were purified by chromatography (CH₂Cl₂/MeOH; 3%), giving pure N-protected 5′-O-fluorenylmethyloxycarbonyl-2′-deoxynucleosides as white solids.

### A) 6-N-Benzoyl-5′-O-fluorenylmethyloxycarbonyl-2′-deoxyadenosine (3.29 g, 81%)

¹H NMR (DMSO): δ (ppm) 11.28 (s, 1H, HNCO); 8.65 (s, 1H, H8); 8.57 (s, 1H, H2); 7.29-8.12 (m, 13H, H—Ar); 6.38 (m, 1H, H1′); 5.51 (d, 1H, 3′OH); 4.47-4.68 (m, 2H, CH₂-COO); 4.43 (m, 1H, H4′); 4.26-4.32 (m, 2H, H5′, H5″); 3.98 (m, 1H, H3′); 2.11-2.51 (m, 3H, CH of Fmoc, H2′, H2″).

### B) 4-N-Benzoyl-5′-O-fluorenylmethyloxycarbonyl-2′-deoxycytidine (3,13 g, 76%)

¹H NMR (DMSO): δ (ppm) 11.32 (s, 1H, H—N4); 7.80-8.02 (m, 6H, H6, H—Ar); 7.27-7.69 (m, 8H, H—Ar); 6.19 (m, J=6Hz, 1H, H1′), 5,30 (d, J=4.2 Hz, 1H, 3′OH); 4.50-4.59 (m, 2H, CH₂—COO); 4.38 (m, 1H, H4′); 4.28-4.33 (m, 2H, H5′, H5″); 4.20 (m, 1H, H3′); 2.01-2.45 (m, 3H, CH of Fmoc, H2′, H2″).

### C) 2-N-iso-Butyryl-5′-O-fluorenylmethyloxycarbonyl-2′-deoxyguanosine (2.4 g, 67%)

¹H NMR (DMSO): δ (ppm) 12.11 (s, 1H, HNCO); 11.86 (s, 1H, H—N1); 7.31-8.15 (m, 9H, H8, H—Ar); 6.17 (t, J=5.8 Hz, 1H, H1′); 5.15 (d, 1H, 3′OH); 4.38-4.59 (m, 2H, CH₂—COO); 4.28 (m, 1H, H4′); 4.19-4.27 (m, 2H, H5′, H5″); 4.06 (m, 1H, H3′); 2.69-2.78 (m, 1H, CH of i-Bu); 2.10-2.48 (m, 3H, CH of Fmoc, H2′, H2″); 1.10 and 1.07 (s, 6H, CH₃ of i-Bu).

### D) 5′-O-Fluorenylmethyloxycarbonylthymidine(3.25 g, 85%)

¹H NMR (DMSO): δ (ppm) 11.27 (s, 1H, H—N3); 7.27-7.85 (m, 9H, H6, H—Ar); 6.31 (t, J=4.5 Hz, 1H, H1′); 5.01 (d, 1H, 3′OH); 4.41-4.58 (m, 2H, CH₂—COO); 4.39 (m, 1H, H4′); 4.09-4.35 (m, 2H, H5′, H5″); 3.87 (m, 1H, H3′); 2.03-2.41 (in, 3H, H2′, H2″, CH of Fmoc); 1.98 (s, 3H, CH₃).

### 2.3. N-Protected 5′-O-fluorenylmethyloxycarbonyl-2′-deoxynucleoside 3′-phosphoramidites (10 A-D)

N-protected 5′-O-fluorenylmethyloxycarbonyl-2′-deoxynucleoside 3′-phosphoramidites were obtained in the following procedure:

N-protected 5′-O-fluorenylmethyloxycarbonyl-2′-deoxynucleoside (1 eq.) and thioethylotetrazole (0.9 eq.) were dried overnight over P₂O₅ in a vacuum dessicator. Next, the protected 2′-deoxynucleoside was dissolved in methylene chloride (20 mL) and bis(N,N′-diisopropylamine)(2-cyanoethoxy)phosphine (1.1 eq.) and thioethyltetrazole (portionwise) were added. After 1 hour ³¹P NMR analysis showed full phosphine conversion. Saturated solution of NaHCO₃ was added to the reaction mixture and then extracted with three portions of CH₂Cl₂. The organic layers were combined, dried on anhydrous Na₂SO₄ and the solvents were evaporated under reduced pressure. Next, the N-protected 5′-O-fluorenylmethyloxycarbonyl-2′-deoxynucleoside 3′-phosphoramidites were dissolved in 3 mL of methylene chloride and precipitated from n-hexane (800 mL).

### A) 6-N-Benzoyl-5′-O-fluorenylmethyloxycarbonyl-2′-deoxyadenosine 3′-phosphoramidite (3.7 g, 85%)

³¹P NMR (CH₂Cl₂): δ (ppm) 148.97, 148.84.

¹H NMR (DMSO): δ (ppm) 10.99 (s, 1H, H—N4); 8.76 (d, J=2 Hz, 1H, H8); 8.65 (d, J=5.6 Hz, 1H, H2); 7.59-8.13 (m, 13H, H—Ar); 6.54 (m, 1H, H1′); 4.84 (m, 1H, H4′); 4.27-4.52 (m, 5H, H5′, H5″, CH, CH₂ of Fmoc); 3.84 (m, 2H, CH₂ of Fmoc); 3.64 (m, 1H, H3′); 3.09 (m, 2H, [i-Pr]); 2.77 (m, 2H, CH₂ of Fmoc); 2.34-2.61 (m, 2H, H2′, H2″); 1.18 (s, 12H, [i-Pr]).

¹³C NMR (DMSO): δ (ppm) 165.67 (CO—Ph); 154.22 (C4); 151.73 (C2); 151.50 (O—CO—O); 150.48 (C8); 143.31 (C4); 140.75; 139.39; 137.40; 133.43; 132.42; 129.15 (Ar); 128.88 (C5); 128.56; 128,47; 128.43; 127,69; 127.25; 127.12; 125.99; 124.87; 121.35; 120.15 (Ar); 118.98 (CN); 83.86 (CH₂ of Fmoc); 83.04 (C1′); 82.75 (C4′); 68.88 (C5′); 58.54 (C3′); 58.36 (CH of Fmoc); 42.71; 42.60 (i-Pr); 37.30 (C2′); 24.39; 24.33; 24.24; 24.16 (i-Pr); 19.80 (CH₂ of cyanoethylof cyanoethyl).

### B) 4-N-Benzoyl-5′-O-fluorenylmethyloxycarbonyl-2′-deoxycytidine 3′-phosphoramidite (3.7 g, 87%)

³¹P NMR (CH₂Cl₂): δ (ppm) 149.15, 148.98.

¹H NMR (DMSO): δ (ppm) 11.26 (s, 1H, H—N4); 7.81-8.09 (m, 5H, H6, H—Ar); 7.28-7.64 (m, 9H, H—Ar); 6.21 (m, 1H, H1′); 4.26-4.56 (m, 7H, H5, H4′, H5′, H5″, CH, CH₂ of Fmoc); 3.78 (m, 2H, CH₂of cyanoethyl); 3.42-3.57 (m, 3H, H3′, i-Pr); 2.73-2.80 (m, 2H, CH₂ of cyanoethyl); 2.19-2.27 (m, 2H, H2′, H2″); 1.15 (s, 12H, CH₃ [i-Pr]).

¹³C NMR (DMSO): δ (ppm) 167.49 (CO—Ph); 165.46 (C4); 163.08 (C2); 154.21 (O—CO—O); 144.83 (C6); 143.42; 143.39; 143.22; 142.55; 140.77; 140.70; 139.39; 137.40; 133.53; 133.13; 132.71; 129.19; 128.89; 128.41; 128.15; 127.42; 127.25; 127.10; 124.82 (Ar); 119.99 (CN); 96.38 (C5); 86.60 (CH₂ of Fmoc); 72.86 (C4′); 68.89 (C5′); 66.91 (C3′); 58.43 (CH₂ of cyanoethylof cyanoethyl); 46.22 (Fmoc); 44.54 (C1′); 42.72 (i-Pr); 24.35; 24.28; 24.22; 24.14 (i-Pr); 19.75 (CH₂ of cyanoethylof cyanoethyl).

### C) 2-N-iso-butyryl-5′-O-fluorenylmethyloxycarbonyl-2′-deoxyguanosine 3′-phosphoramidite (2.9 g, 89%)

³¹P NMR (CH₂Cl₂): δ (ppm) 149.15, 148.98.

¹H NMR (DMSO): δ (ppm) 11.65 (s, 1H, H—NCO); 8.20 (d, J=4.8 Hz, 1H, H8); 7.83-7.89 (m, 2H, H—Ar); 7.61-7.65 (m, 2H, H—Ar); 7.30-7.43 (m, 4H, H—Ar); 6.26 (t, J=7.2 Hz, 1H, H1′); 4.60 (m, 1H, H4′); 4.46-4,55 (m, 2H, CH₂ of Fmoc); 4.21-4.34 (m, 3H, H5′, H5″, CH of Fmoc); 4.15 (m, 1H, H3′); 3.68-3.80 (m, 2H, CH₂ of cyanoethylof cyanoethyl); 3.52-3.62 (m, 2H, CH [i-Pr]); 2.91 (m, 1H, CH of i-Bu); 2.73-2.79 (m, 2H, CH₂ of cyanoethylof cyanoethyl); 2.42-2.55 (m, 2H, H2′, H2″); 1.23 (s, 6H, CH₃ of i-Bu); 1.32 (s, 12H, CH₃ [i-Pr]).

¹³C NMR (DMSO): δ (ppm) 180.13 (CO of i-Bu); 180.06 (C6); 154.79 (C2); 154.20 (O—CO—O), 148.50 (C8); 143.23; 143.20 (Ar); 140.78 (C4); 140.75 (C5); 139.39; 137.40; 137.29; 128.88; 127.70; 127.75; 127.11; 124.84; 124.18; 121.35; 120.17 (Ar); 119.99 (CN); 82.99 (CH₂ of Fmoc); 82.82 (C4′); 68.88 (C5′); 66.95 (C1′); 61.16 (C3′); 58.45 (CH₂ of cyanoethyl); 46.17 (CH of Fmoc); 42,66 (CH of i-Bu and [i-Pr]); 34.73 (C2′); 24,29 (CH₃ of i-Bu); 22.03 (CH₂ of cyanoethyl); 18.82 (CH₃ of i-Bu).

### D) 5′-O-Fluorenylmethyloxycarbonylthymidine 3′-phosphoramidite (4 g, 86%)

³¹P NMR (CH₂Cl₂): δ (ppm) 149.06, 148.93.

¹H NMR (DMSO): δ (ppm) 11.32 (m, 1H, H—N4); 7.39-7.89 (m, 9H, H6, H—Ar); 6.19 (m, 1H, H1′); 4.53-4.62 (m, 2H, CH₂ of Fmoc); 4,46 (m, 1H, H4′); 4,24-4.35 (m, 3H, H5′, H5″, CH of Fmoc); 4.13 (m, 1H, H3′); 3.64-3.72 (m, 2H, CH₂ of cyanoethyl); 3.52-3.59 (m, 2H, CH [i-Pr]); 2.72-2.79 (m, 2H, CH₂ of cyanoethyl); 2.21-2.36 (m, 2H, H2′, H2″); 1.14 (s, 12H, CH₃ [i-Pr]); 1.10 (CH₃ [T]).

¹³C NMR (DMSO): δ (ppm) 163.59 (C4); 154.28 (C2); 150.33 (O—CO—O); 143.22; 140.79 (Ar); 135.89 (C6); 127.73; 127.24; 124.79; 120.18 (Ar); 118.93 (CN); 109.87 (C5); 84.14 (CH₂ Fmoc); 82.41 (C1′); 82.01 (C2′); 72.89 (C5′); 68.82 (C4′); 58.41 (CH₂ of cyanoethyl); 46.25 (CH of Fmoc); 42.70 (CH [i-Pr]); 37.41 (C2′); 24.33; 24.27; 24.18; 24.12 (CH₃ [i-Pr]); 22.55 (CH₂ of cyanoethyl); 12.06 (CH₃ of T).

Standard nucleoside 3′-phosphoramidites of nucleosides or their analogues were mixed with terminating agents in 9:1 molar ratio. 0.07 M solutions in acetonitrile were prepared and used for oligonucleotide synthesis.

Oligonucleotides were synthesized in 0.2 μM scale according to the standard program:

| Cycle step | Process | Reagent | Time |
|---|---|---|---|
| 1. | Detritylation | 3% TCA in CH₂Cl₂ | 35″ |
| 2. | Coupling | FAdC/FAdT/FAdG/FAdA | 3′50″ |
| | | in CH₃CN | |
| 3. | Capping | Ac₂O, lutidine, NMI in | 30″ |
| | | CH₃CN | |
| 4. | Oxidation | 3% I₂, 10% H₂O in Py | 15″ |

Protective groups were removed from oligonucleotides anchored to the “oxylabile support” by overnight treatment with aqueous 32% ammonia solution at 55° C.

The amount of oligonucleotide(s) on a single support bead does not exceed several picomoles. Analysis of complex mixtures at such minimum quantities is a difficult task. Oxidation of ribose residue cis-diol system is conducted using ammonium periodate.

A single support bead was isolated using a glass capillary. The operation was monitored under a Nikon Diaphot inverted fluorescence microscope. The bead suspended in 0.1-0.2 μL H₂O was placed in an eppendorf tube. Next, the suspension was centrifuged and 0.1 M solution of NH₄IO₄ (0.25 μL) was added. The solution was centrifuged again and set aside for 30 minutes. Next, 0.3 M L-methionine solution (0.25 μL) was added, the mixture was centrifuged and set aside for 2 hours

After cleavage of the nucleotide from the support, the mixture was submitted to MALDI-TOFF analysis.

2,4,6-trihydroxyacetophenone (THAP) was used as the matrix. In order to prepare the matrix solution, 2 mg of THAP were dissolved in 200 μL of MeCN/H₂O mixture (1:1) and 0.1 M diammonium citrate solution (70 μL) was added. The mixture was shaken and centrifuged.

Analyses were performed by the dried droplet method on prestructured MALDI AnchorChip plates with spot diameters of 600 and 400 μm. Oligonucleotide solution (0.5 μL) was applied onto the spot, followed by the matrix solution. The mixture was stirred using the pipette tip. In order to maintain uniform crystallization conditions (air humidity), plates were placed over a drying agent (CaO) in a dessicator.

An exemplary MALDI-TOF spectra were obtained for the oligonucleotide of the following sequence: 5′-d(CGG ATT TAT GCA)-3′and the oligonucleotide analogue: 5′-d(ATT C^{Sp}PGT GTG CAG A)-3′. The first three nucleotides must be known, since the signals representing these nucleotides are located in the region of matrix signals.

FIG. 1 presents exemplary MALDI-TOF spectra obtained for liberated from the single polystyrene bead oligonucleotides of following respective sequences: 5′-d(CGG ATT TAT GCA)-3′, 5′-d(ATC GAC CTC AAT)-3′, 5′-d(3ATT CGT TTG GAG A)-3′, 5′-d(ATT CGT CTG CAG A)-3′.

FIG. 2 presents exemplary MALDI-TOF spectrum obtained for liberated from the single polystyrene bead oligonucleotide analogue of respective sequence, where C^{Sp}=4-N-(4,9,13-Triazatridecan-1-yl)-2′-deoxycytidine, the modified 2′-deoxycytidine residue.

The FIG. 2 presents an exemplary MALDI-TOF spectrum of liberated from the single polystyrene bead oligonucleotide analogue of the sequence 5′-d(ATT C^{Sp}GT GTG CAG A)-3′ and strictly prove that elaborated and described here method could serve for sequencing as well oligonucleotide as oligonucleotide analogues combinatorial libraries.

The type and order of nucleotides and/or their analogues in the sequence is determined from calculation of mass differences between two adjacent signals within the spectrum, corresponding to nucleotide or analogue masses. Calculation starts with the signal of the highest m/z value. The left-to-right spectrum sequence is interpreted in 3′→5′ direction. Units at the 3′ terminus of the oligomer, having molecular mass of up to 1000 Da, are predefined, since the signals that represent these units are located in the region of matrix signals; the sequence is a part of the library or a mass marker—a chemical compound structurally different from the components of the oligonucleotide or its analogue).

### Example 2

Preparation of “oxylabile” support 2: i) TMSCl, Py; ii) 1,2-bis[(dimethylamine)-methylene]hydrazine, Py; iii) DMTCl, Py; iv) 2,2′-(ethylenedioxy)-bis(ethylamine), Py; v) DCC, DMAP, Et₃N, CH₂Cl₂, vi) NH₃ aq; vii) Ac₂O, NMI, 2,6-lutidine, MeCN.

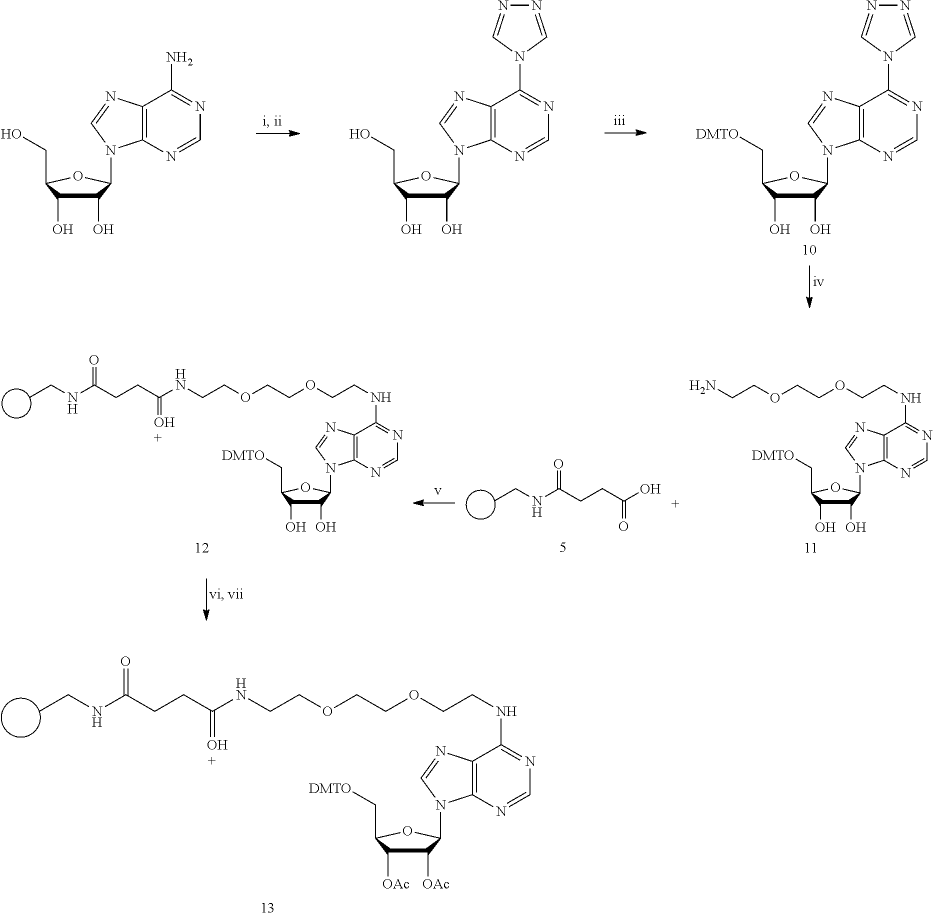

The synthesis of “oxylabile” support 2 (13) was conducted in following stages:

### 3.1. 9-[5′-O-(4,4′-dimethoxytrityl)-(β-D-erythro-pentofuranosyl)]-6-(1,2,4-triazol-4-yl)purine (10)

Adenosine (1 eq.) was evaporated with pyridine (three times) and then dissolved in pyridine, and trimethylsilyl chloride (5 eq.) was added. After about 1 hour of stirring at room temperature, the substrate was quantitatively converted. The silylation product was directly submitted to next reaction. 1,2-bis[(dimethylamino)-methylene]hydrazine (4 eq.) was added to the reaction mixture. The resulting solution was refluxed at pyridine boiling point (96-100° C.) for 24 hours. After this time, TLC analysis showed full substrate conversion. Excess silyl chloride was decomposed by adding saturated NaHCO₃ solution. The aqueous phase was extracted with three portions of methylene chloride. Combined organic layers were dried on anhydrous Na₂SO₄. The solvents were evaporated under reduced pressure. Next, the crude product was dissolved in 10 mL of MeOH and left for 10 hours at room temperature. The product 10 was crystallized from methanol. Crystals were filtered off and washed with hexane and diethyl ether. The product 10 was then dried by evaporation with pyridine (three times) and dissolved in pyridine. 4,4′-dimethoxytrityl chloride (1.1 eq.) was added. The reaction mixture was left on a magnetic stirrer for about 6 hours at room temperature. The reaction was stopped by adding saturated solution of NaHCO₃, which was then extracted with three portions of CH₂Cl₂. After organic layers were combined, dried on anhydrous Na₂SO₄ and evaporated under reduced pressure, the dry product was purified by chromatography (CH₂Cl₂/MeOH, 2-4%). Pure 9-[5′-0-(4,4′-dimethoxytrityl)-(β-D-erythro-pentofuranosyl)]-6-(1,2,4-triazol-4-yl)purine (10) was obtained as white oil. White solid was obtained after lyophilization from benzene.

### 3.2. 4-N-(8-Amino-3,6-dioxaoctyl)-5′-O-(4,4′-dimethoxytrityl)adenosine (11)

9- [5′-O-(4,4′-dimethoxytrityl)-(β-D-erythro-pentofuranosyl)]-6-(1,2,4-triazol-4-yl)purine (10) (1 eq.) was evaporated three times with pyridine to remove the trace amounts of water. Next, the substrate was dissolved in pyridine (20 mL) and 2,2′-(ethylenedioxy)-bis(ethylamine) (5.5 mL, 44.45 mmol, 7 eq.) was added. The flask was tightly closed and placed overnight in an oven at 80° C. In the morning, TLC analysis (MeOH:H₂O:CH₃NH₂, 7:2:1) was performed, showing quantitative conversion of the substrate. The reaction mixture was diluted with 30 mL of H₂O. The aqueous layer was extracted with three portions of AcOEt (in case of emulsification, the solution was centrifuged). Organic layers were combined and dried on anhydrous Na₂SO₄. After the solvents were evaporated under reduced pressure, the crude product was purified by chromatography (CH₂Cl₂/MeOH, 6:4), Pure 4-N-(8-Amino-3,6-dioxaoctyl)-5′-O-(4,4′-dimethoxytrityl)adenosine (11) was obtained as white foam.

### 3.3. “Oxylabile Support” (13)

Methylamine-functionalized polystyrene support (50 mg) was suspended in 1 mL of anhydrous CH₂Cl₂ and succinic anhydride (50 mg), Et₃N (50 μL) and DMAP (20 mg) were added. The flask was tightly closed and shook overnight at room temperature. In the morning, the support was filtered off and washed with MeOH (50 mL) and CH₂Cl₂ (50 mL). Next, the support was dried in the air. The resulting carboxyl group-carrying support (5) (1 g) was suspended in 10 mL of methylene chloride. 4-N-(8-Amino-3,6-dioxaoctyl)-5′-O-(4,4′-dimethoxytrityl)adenosine (11) (1 g, 1.5 mmol, 1 eq.), DCC (700 mg, 1.5 mmol, 1 eq.), Et₃N (450 μL, 1.5 mmol, 1 eq.) and DMAP (20 mg) were added to the suspension. The mixture was shook overnight at room temperature. The support was filtered off and washed with methanol (50 mL) and methylene chloride (50 mL). 10 mL of NH₃ aq. (32%) were added to decompose the by-products. The reaction was conducted for 4 hours at 60° C. Next, support beads (12) were suspended in MeCN (10 mL) and acetic anhydride (500 μL), N-methyloimidazole (1.34 mL) and 2,6-lutidine (500 μL) were added. The mixture was shook for 2 hours; after this time, support 13 was filtered off, washed with MeOH, CH₂Cl₂ and dried in the air.

1. A combinatorial library of oligonucleotides and/or oligonucleotide analogues characterized in that it includes a linker of formula (I) 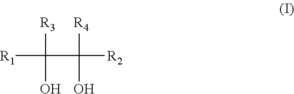
chemically linked to the support, where R₁ and R₂ are independently two substituents of any type terminated with functional groups, and R₃ and R₄ are independent or together form a cyclic system, and
at least one oligonucleotide and/or oligonucleotide analogue comprising a part of combinatorial library oligonucleotide and/or oligonucleotide analogue pool,
wherein the oligonucleotides and/or oligonucleotide analogues are comprised of natural nucleotides and/or nucleotide analogues.

2. A library according to claim 1, wherein when in the linker of formula 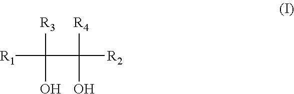
R₃ and R₄ together form a cyclic system, the linker preferably comprises a residue of formula (II) 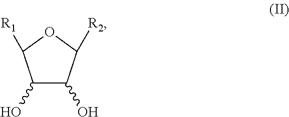
where R₁ and R₂ are independent substituents terminated with any functional groups.

3. The method of preparation of a combinatorial library of oligonucleotides and/or oligonucleotide analogues, characterized in that it includes
d) preparation of a linker of formula (I) 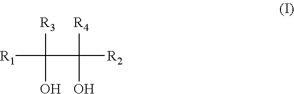
chemically linked to the support, where R₁ and R₂ are independently two substituents of any type terminated with functional groups, and R₃ and R₄ are independent or together form a cyclic system,
e) chemical linking of the linker and the support;
f) preparation of a series of nucleotides and/or nucleotide analogues having at least two substituents of functional nature, wherein each nucleotide and/or nucleotide analogue has at least one corresponding terminating agent, wherein the functional group of the nucleotide and/or nucleotide analogue, to which another unit of the growing chain is added during the synthesis, is blocked in the structure of the terminating agent by a protective group stable in the oligonucleotide and/or oligonucleotide analogue synthesis conditions and labile in final product deprotection conditions, without breaking the linker between the library element and the support,
wherein the terminating agents are used in oligonucleotide synthesis together with the nucleotides and/or nucleotide analogues, wherein their quantitative ratio is fixed or variable, not higher than 50% of the terminating agent in relation to the monomer at successive stages of oligonucleotide and/or oligonucleotide analogue synthesis.

4. A method according to claim 3, characterized in that the terminating agents are used preferably from the stage of linking the fifth monomer, particularly preferably the eight monomer, the monomer is used at the terminator/monomer ratio of at least 7%.

5. A method of sequence identification preceded or not preceded by a combinatorial oligonucleotide or oligonucleotide analogue library element selection stage, characterized in that it comprises the stage described in one of claim 3 or 4, and that a single support bead is isolated, followed by cleavage of the vicinal diol system in the linker as a result of an oxidizing agent consisting in ammonium periodate NH₄IO₄ or ammonium periodate of formula [R₁R₂R₃R₄N]⁺[IO₄]⁻, wherein R₁, R₂, R₃ and R₄ are independently alkyl groups or hydrogen atoms, thus releasing the oligonucleotide comprised of nucleotides and/or oligonucleotide analogues from the support, wherein when the linker structure is as in formula (II), final detachment of the oligonucleotide comprised of nucleotides and/or oligonucleotide analogues from the support is a result of treatment with a basic agent; next, the mixture of oligonucleotides of different length, detached from the support bead is submitted to spectroscopic analysis.

6. A method according to claim 3, wherein the basic agent preferably is methionine.

7. A method of sequencing the elements of combinatorial oligonucleotide and/or oligonucleotide analogue libraries characterized in that it involves the stages described above and that the type and order of nucleotides and/or their analogues in the sequence is determined from calculation of mass differences between two adjacent signals within the spectrum, corresponding to nucleotide or analogue masses, wherein calculation starts with the signal of the highest m/z value.

8. Use of the linker of formula (I) 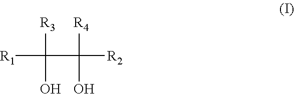
chemically linked to the support, where R₁ and R₂ are independently two substituents of any type terminated with functional groups, and R₃ and R₄ are independent or together form a cyclic system, and
at least one oligonucleotide and/or oligonucleotide analogue comprising a part of combinatorial library oligonucleotide and/or oligonucleotide analogue pool, wherein the oligonucleotides and/or oligonucleotide analogues are comprised of natural nucleotides and/or nucleotide analogues for preparation of combinatorial oligonucleotide and/or oligonucleotide analogue libraries.

9. Use according to claim 8, wherein when in the linker of formula (I) 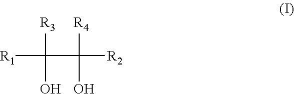
R₃ and R₄ together form a cyclic system, the linker preferably comprises a residue of formula (II) 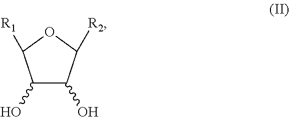
where R₁ and R₂ are independent substituents terminated with any functional groups.

10. A sequence identification set, characterized in that it includes a linker of formula (I), 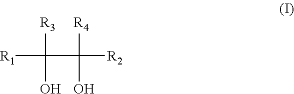
chemically linked to the support, where R₁ and R₂ are independently two substituents of any type terminated with functional groups, and R₃ and R₄ are independent or form a cyclic system, and
at least one oligonucleotide and/or oligonucleotide analogue comprising a part of combinatorial library oligonucleotide and/or oligonucleotide analogue pool,
wherein the oligonucleotides and/or oligonucleotide analogues are comprised of natural nucleotides and/or nucleotide analogues.

11. A set according to claim 10, characterized in that when in the linker of formula (I) 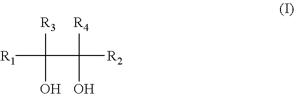
R₃ and R₄ together form a cyclic system, the linker preferably comprises a residue of formula (II) 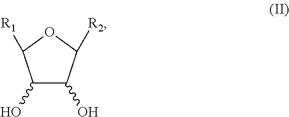
where R₁ and R₂ are independent substituents terminated with any functional groups.
